(19) United States
(12) Patent Application Publication
(10) Pub. No.: US 2012/0143590 A1
(43) Pub. Date: Jun. 7, 2012

(54) ELECTRONIC BOOK SYSTEM AND CONTENT SERVER

(75) Inventor: Yukinao Ajima, Tokyo (JP)

(73) Assignee: For+side.com Co., Ltd, Tokyo (JP)

(21) Appl. No.: 12/921,723

(22) PCT Filed: May 7, 2010
(86) PCT No.: PCT/JP2010/057798

§ 371 Date: Sep. 9, 2010

(51) Int. Cl. G06F 3/01; G06F 17/28; G10L 11/00; G06Q 30/02

(52) U.S. Cl. 704/2; 705/14.49; 704/270; 715/751; 704/E11.001

(57) ABSTRACT

An electronic book system for providing services for improving the user convenience by sharing, acquiring and analyzing text information included in an electronic book is provided. According to a typical embodiment of the present invention, the electronic book system is made up of a content server and a terminal having a viewer connected to the content server to browse the electronic book, wherein the viewer has a comment input unit which receives an input of a comment to be added to a desired position of the electronic book and transmits information including the comment and the position to add the comment to the content server, and the content server has a comment processing unit which retains the information of the comment transmitted from the viewer in a comment storage unit in association with the information of the user and the position to add the comment and acquires the information of the comment added by each user to a position of the browsing electronic book from the comment storage unit to display it in the viewer when the user browses the electronic book by using the viewer.

### CROSS REFERENCE TO RELATED APPLICATIONS

This application is entitled to the benefit of and incorporates by reference essential subject matter disclosed in International Patent Application No. PCT/JP2010/057798 filed on May 7, 2010.

### TECHNICAL FIELD

The present invention relates to a technology for the provision of an electronic book service, and more particularly to a technology effectively applied to an electronic book system and a content server that provide various services including information sharing and others by the use of text information relating to an electronic book.

### BACKGROUND ART

In recent years, release and use of publications by means of electronic books have been rapidly spreading. The factors of this include the widespread use of a mobile terminal such as a mobile phone capable of browsing the content of the electronic book in addition to the PC (Personal Computer) and others. Furthermore, the use of dedicated terminals for browsing the electronic book using the technology of electronic paper and others has also been spreading recently.

In such a circumstance, various mechanisms for improving the user convenience in addition to allowing the user to simply browse content such as the electronic book and the newspaper article (hereinafter, simply referred to as “electronic book”) have been proposed. Examples thereof include a function by which the user can write a comment in an arbitrary place of the electronic book as if to put a tag. Furthermore, the utility form in which the written comments are mutually sent between users by using a communication function of the terminal has also been proposed.

As a technology relevant to those described above, for example, Japanese Patent Application Laid-Open Publication No. 2008-20961 discloses a technology in which when an instruction to close the display showing a part associated with a comment in an electronic book currently displayed on a display screen is received from a user, the comment is displayed on the screen, so that the comment is displayed after the end of the browse of the part associated with the comment and the comment can be displayed to the user browsing the content at the optimum timing.

Also, as an example using text information of a text of an electronic book, for example, Japanese Patent Application Laid-Open Publication No. 2006-53739 discloses a technology for an electronic book reading machine in which data of an electronic bookmark is read together with book data from an electronic book, a read start position is set based on the data of the electronic bookmark, the book data after the read start position is read and converted to a sound signal, and the signal is supplied to a speaker through an amplifier.

Furthermore, for example, Japanese Patent Application Laid-Open Publication No. 2006-331056 discloses a technology in which the control is carried out so that information relating to a keyword that is a character string specified by a user in the content of an electronic book is acquired from a server connected to the Internet, a dictionary database or stored information in a storage unit in accordance with a renewal deadline, whereby the appropriate information can be easily and quickly acquired from a wide range of information sources and information relating to the arbitrary character string in the electronic book can be acquired while maintaining the display of the electronic book.

### DISCLOSURE OF THE INVENTION

As described above, various mechanisms for improving the user convenience have been proposed for the electronic book. In these mechanisms, however, the process to the text information in the electronic book, the data retention and the management of the comments are mainly performed individually on a side of a terminal, and the degree of the improvement in the user convenience is limited within the range of the utilization of the terminal of the user. Furthermore, the load on the side of the terminal (processing load and capacity of storage area) is increased, and the influence is sometimes large when using a mobile terminal or the like.

If the text information of the electronic book (including information relating to comments provided by users) can be managed in a server in an integrated fashion and shared with a plurality of users and the acquisition and analysis of the contents of the text information can be performed, various services capable of further improving the user convenience can be provided.

Therefore, an object of the present invention is to provide an electronic book system and a content server capable of providing services for improving the user convenience by sharing, acquiring and analyzing the text information included in the electronic book or provided to the electronic book by users. The above and other objects and novel characteristics of the present invention will be apparent from the description of the present specification and the accompanying drawings.

The following is a brief description of an outline of the typical invention disclosed in the present application.

An electronic book system according to a typical embodiment of the present invention comprises: a content server which retains and manages a content including an electronic book and provides a service regarding a browse of the content including the electronic book through a network; and one or more terminals which include viewers connected to the content server through the network to browse the electronic book, and the electronic book system has following characteristics.

That is, in the electronic book system, the viewer has comment input means which receives an input of a comment to be added to a desired position of the electronic book from a user and transmits information including the comment and the position to add the comment to the content server, and the content server has a comment processing unit which retains the information of the comment transmitted from the viewer in comment storage means in association with the information of the user and the position to add the comment, and which acquires the information of the comment added by each user to a position of the browsing electronic book from the comment storage means to display it in the viewer when the user browses the electronic book by using the viewer.

The effects obtained by typical embodiments of the invention disclosed in the present application will be briefly described below.

According to a typical embodiment of the present invention, it is possible to provide the services for improving the user convenience by sharing, acquiring and analyzing the text information included in the electronic book or provided to the electronic book by users.

### BRIEF DESCRIPTIONS OF THE DRAWINGS

FIG. 1 is a diagram showing an outline of a configuration example of an electronic book system according to an embodiment of the present invention;

FIG. 2 is a diagram showing an example of a data configuration of a content DB according to an embodiment of the present invention;

FIG. 3 is a diagram showing an example of a data configuration of a member DB according to an embodiment of the present invention;

FIG. 4 is a diagram showing an example of a data configuration of a comment DB according to an embodiment of the present invention;

FIG. 5 is a diagram showing an example of a data configuration of a freehand memo DB according to an embodiment of the present invention;

FIG. 6 is a diagram showing an example of a data configuration of a display advertisement DB according to an embodiment of the present invention;

FIG. 7 is a diagram showing an example of the flow of the processes when browsing a comment added to a content according to an embodiment of the present invention;

FIG. 8A is a diagram showing an example of the screen when displaying the content and the comment according to an embodiment of the present invention;

FIG. 8B is a diagram showing an example of the screen when displaying the content and the comment according to an embodiment of the present invention;

FIG. 8C is a diagram showing an example of the screen when displaying the content and the comment according to an embodiment of the present invention;

FIG. 8D is a diagram showing an example of the screen when displaying the content and the comment according to an embodiment of the present invention;

FIG. 9 is a diagram showing an example of the flow of the processes when updating and adding a comment to a content according to an embodiment of the present invention;

FIG. 10A is a diagram showing an example of the screen when adding a comment to a keyword of a content according to an embodiment of the present invention;

FIG. 10B is a diagram showing an example of the screen when adding a comment to a keyword of a content according to an embodiment of the present invention;

FIG. 10C is a diagram showing an example of the screen when adding a comment to a keyword of a content according to an embodiment of the present invention;

FIG. 10D is a diagram showing an example of the screen when adding a comment to a keyword of a content according to an embodiment of the present invention;

FIG. 11 is a diagram showing an example of the flow of the processes when searching and browsing a comment added to a content according to an embodiment of the present invention;

FIG. 12 is a diagram showing an example of the flow of the processes when adding a freehand memo to a page of a content according to an embodiment of the present invention;

FIG. 13A is a diagram showing an example of the screen when adding a freehand memo to a page of a content according to an embodiment of the present invention;

FIG. 13B is a diagram showing an example of the screen when adding a freehand memo to a page of a content according to an embodiment of the present invention;

FIG. 14A is a diagram showing an example of the screen when displaying a freehand memo saved in a terminal according to an embodiment of the present invention;

FIG. 14B is a diagram showing an example of the screen when displaying a freehand memo saved in a terminal according to an embodiment of the present invention;

FIG. 15A is a diagram showing an example of the screen when displaying a freehand memo saved in a content server according to an embodiment of the present invention;

FIG. 15B is a diagram showing an example of the screen when displaying a freehand memo saved in a content server according to an embodiment of the present invention;

FIG. 15C is a diagram showing an example of the screen when displaying a freehand memo saved in a content server according to an embodiment of the present invention;

FIG. 15D is a diagram showing an example of the screen when displaying a freehand memo saved in a content server according to an embodiment of the present invention;

FIG. 16A is a diagram showing another example of the screen when displaying a freehand memo saved in a content server according to an embodiment of the present invention;

FIG. 16B is a diagram showing another example of the screen when displaying a freehand memo saved in a content server according to an embodiment of the present invention;

FIG. 16C is a diagram showing another example of the screen when displaying a freehand memo saved in a content server according to an embodiment of the present invention;

FIG. 16D is a diagram showing another example of the screen when displaying a freehand memo saved in a content server according to an embodiment of the present invention;

FIG. 17 is a diagram showing an example of the flow of the processes when adding a comment to a content (electronic article) such as newspaper article and news according to an embodiment of the present invention;

FIG. 18A is a diagram showing an example of the screen when displaying a content of an electronic article and a comment according to an embodiment of the present invention;

FIG. 18B is a diagram showing an example of the screen when displaying a content of an electronic article and a comment according to an embodiment of the present invention;

FIG. 18C is a diagram showing an example of the screen when displaying a content of an electronic article and a comment according to an embodiment of the present invention;

FIG. 19A is a diagram showing an example of the screen when adding a comment to a content of an electronic article according to an embodiment of the present invention;

FIG. 19B is a diagram showing an example of the screen when adding a comment to a content of an electronic article according to an embodiment of the present invention;

FIG. 19C is a diagram showing an example of the screen when adding a comment to a content of an electronic article according to an embodiment of the present invention;

FIG. 19D is a diagram showing an example of the screen when adding a comment to a content of an electronic article according to an embodiment of the present invention;

FIG. 20 is a diagram showing an example of the flow of the processes when a keyword of a content is searched with a dictionary and when text information of a content is translated and browsed according to an embodiment of the present invention;

FIG. 21A is a diagram showing an example of the screen when searching a keyword of a content with a dictionary according to an embodiment of the present invention;

FIG. 21B is a diagram showing an example of the screen when searching a keyword of a content with a dictionary according to an embodiment of the present invention;

FIG. 22A is a diagram showing an example of the screen when translating and browsing text information of a content according to an embodiment of the present invention;

FIG. 22B is a diagram showing an example of the screen when translating and browsing text information of a content according to an embodiment of the present invention;

FIG. 22C is a diagram showing an example of the screen when translating and browsing text information of a content according to an embodiment of the present invention;

FIG. 23A is a diagram showing an example of the screen in the case of synchronously reproducing sound information when browsing a content according to an embodiment of the present invention; and

FIG. 23B is a diagram showing an example of the screen in the case of synchronously reproducing sound information when browsing a content according to an embodiment of the present invention.

### BEST MODE FOR CARRYING OUT THE INVENTION

Hereinafter, embodiments of the present invention will be described in detail with reference to the accompanying drawings. Note that components having the same function are denoted by the same reference symbols throughout the drawings for describing the embodiments, and the repetitive description thereof will be omitted.

In an electronic book system according to an embodiment of the present invention, various services capable of further improving the user convenience are provided by managing the text information of the electronic book (including information relating to comments provided by users) in a content server in an integrated fashion and sharing the information with a plurality of users and also performing the acquisition and analysis of the contents of the text information.

More specifically, the system has a function by which a user can add a comment to an electronic book which the user is browsing and the comment can be shared with other users. This comment can be added not only to a unit such as a page or a frame of the electronic book but also to a text (keyword). At this time, for example, it is also possible to provide a comment to a specific user and post a comment to various types of so-called SNS (Social Networking Service) sites. Furthermore, the system has also a function by which the analysis based on the accumulation of the information relating to the comments added by a user is performed to recommend an optimum electronic book and display an advertisement to the user.

In addition, the system has also a function by which a memorandum written freehand (hereinafter, referred to as “freehand memo”) to an electronic book is added as a comment and the freehand memo is shared with other users. Furthermore, the system has also a function by which the dictionary search to a keyword is performed and a text is automatically translated to be displayed and reproduced synchronously with sound information by using the text information included in the electronic book.

### <System Configuration>

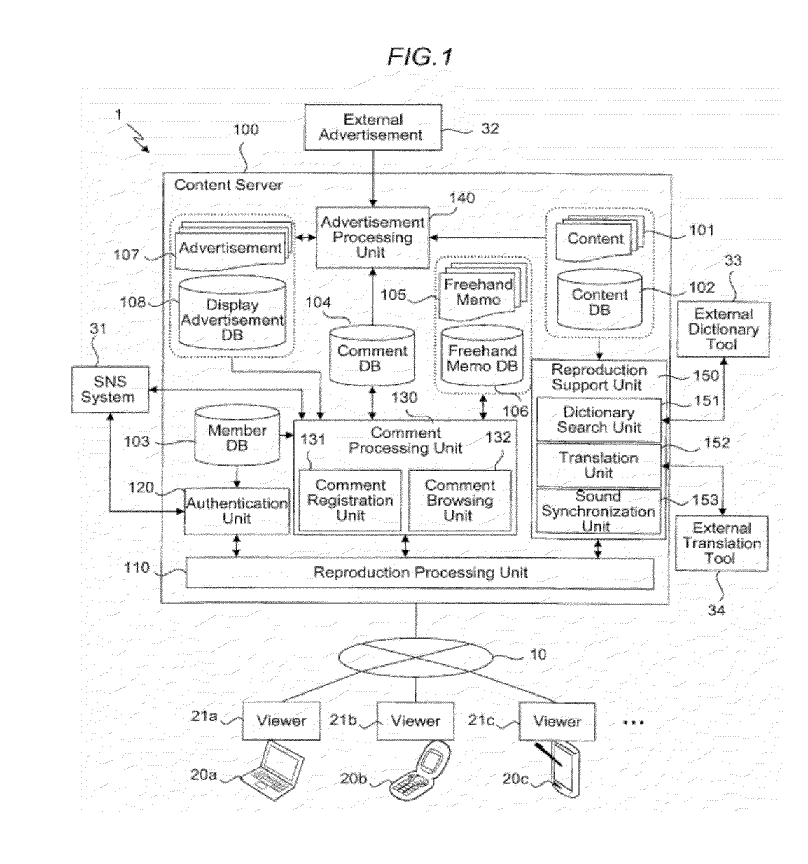

FIG. 1 is a diagram showing an outline of a configuration example of an electronic book system according to an embodiment of the present invention. An electronic book system 1 has a configuration in which various terminals 20 possessed by users are connected to a content server 100, which manages a content including an electronic book and text information of the electronic book (including information relating to comments added by users), through a network 10 such as the Internet and viewers 21 corresponding to software programs for browsing the electronic book.

The electronic book mentioned here corresponds to books such as novels and comics and contents of publications such as news and articles published as the content by digital information, and it indicates the content that can be browsed through a display screen of an information processing unit. Although various types exist for the file format of the electronic book, the electronic book in the present embodiment is defined to be capable of retaining the text information regarding the text in the content together as the content data. In other words, the file format of the electronic book is not particularly limited as long as the text information regarding the content can be included as the electronic book. This file of the electronic book is retained in the content server 100 as the content 101.

The terminal 20 which is an information processing unit by which the user browses the electronic book (content 101) is not limited to the PC (terminal 20a) as long as it can execute the corresponding viewer 21, and various types such as a mobile phone (terminal 20b) and a dedicated terminal for reproducing the electronic book (terminal 20c) can be used. Also, in the present embodiment, as the browsing method of the content 101 using the viewer 21, the content 101 retained on the content server 100 is browsed by the streaming, the browsing and others, but the form in which the content 101 is downloaded and browsed on the terminal 20 is also possible.

The content server 100 is a server system which is made up by a computer system, manages the content 101 and the text information included in the content 101, and provides the browsing service of the content 101 by the viewer 21. This content server 100 includes units installed by software programs such as a reproduction processing unit 110, an authentication unit 120, a comment processing unit 130, an advertisement processing unit 140 and a reproduction support unit 150. Also, the content server 100 further includes databases or tables such as a content DB 102, a member DB 103, a comment DB 104, a freehand memo DB 106 and a display advertisement DB 108.

The reproduction processing unit 110 has an interface which receives a request regarding the browse of the content 101 from the terminal 20 through the viewer 21, and it enables the browse (reproduction) of the content 101 in the viewer 21 by general technologies such as the streaming and the browsing. Note that various types of attribute information relating to the content 101 used to specify and reproduce the content 101 are recorded and managed in the content DB 102.

The authentication unit 120 performs the user authentication for determining whether or not the user is the member of the electronic book service provided by the electronic book system 1 with reference to the member DB 103 when the user of the terminal 20 browses the content 101. Also, it may have a function to perform the user authentication for an external system and a tool cooperating with the content server 100 including various SNS systems 31. The comment processing unit 130 includes, for example, a comment registration unit 131 and a comment browsing unit 132, and it performs such processes as the addition, update and browse of the comment and the freehand memo to the content 101 based on the request from the user through the viewer 21.

The comment registration unit 131 adds a text-based comment to the content 101 which the user is browsing and registers it to the comment DB 104, and adds a freehand memo to the content 101 and registers the information thereof to the freehand memo DB 106. Note that, as the freehand memo 105, for example, the image data of the memo drawn in the viewer 21 by the user is retained as an image file of a transparent format (gif format or png format). Also, the comment registration unit 131 registers the information of the existing freehand memo 105 edited and updated by the user to the freehand memo DB 105.

The comment browsing unit 132 acquires the comment and the freehand memo 105 to be displayed in the viewer 21 with reference to the comment DB 104 and the freehand memo DB 106, respectively, and then displays them in the viewer 21 through the reproduction processing unit 110.

The advertisement processing unit 140 displays the information of the electronic book (content 101) recommended for the user and the so-called target advertisement together when the comment browsing unit 132 displays the comment in the viewer 21. For example, the content of the target advertisement may be periodically acquired from an external advertisement 32 which is an external system for providing advertisement information or may be retained in advance as an advertisement 107 by the registration by the administrator of the electronic book system 1. Also, in order to specify the advertisement 107 to be displayed, the information about where the advertisement 107 is displayed in each content 101 and which of the advertisements 107 is displayed may be determined in advance and retained in the display advertisement DB 108, and the information can be referenced when displaying the advertisement 107.

The reproduction support unit 150 includes, for example, a dictionary search unit 151, a translation unit 152 and a sound synchronization unit 153, and it provides various useful services when the user browses (reproduces) the content 101 in the viewer 21.

The dictionary search unit 151 carries out the search for the text information (keyword) specified by the user in the content 101, which the user browses by using the viewer 21, by using an external dictionary tool 33 which is an external system for providing the dictionary search service, and displays the search result in the viewer 21. Note that it is also possible to dispose the dictionary tool in the content server 100 and use it for the search.

The translation unit 152 carries out the translation for the text information in the content 101, which the user browses by using the viewer 21, by using an external translation tool 34 which is an external system for providing the translation service to other languages, and displays the text information of the translation result in the viewer 21. Note that it is also possible to dispose the translation tool in the content server 100 and use it for the translation.

The sound synchronization unit 153 synchronously reproduces the text information and the sound information of the content 101 and displays it in the viewer 21 when the content 101 which the user browses by using the viewer 21 is accompanied by the sound information or the content 101 and the sound information are managed in association with each other. Note that, as the technology for the synchronous reproduction of the text information and the sound information, for example, the prior art technology known in the karaoke equipment, the language study system and others can be utilized.

### <Data Configuration>

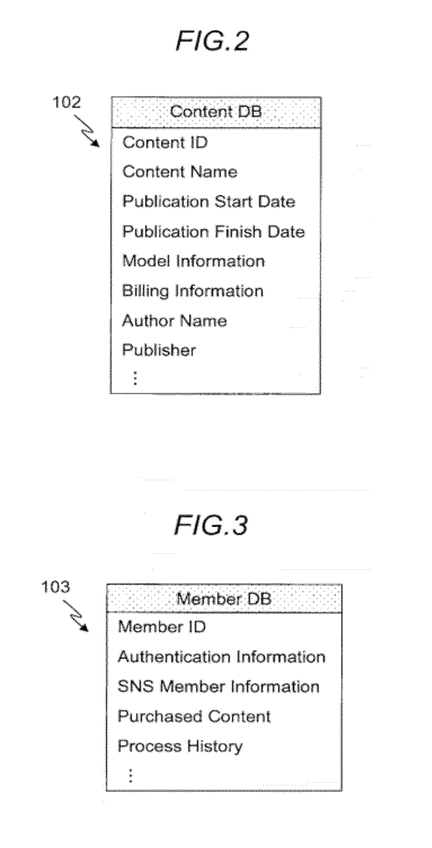

FIG. 2 is a diagram showing an example of a data configuration of the content DB 102. The content DB 102 is a table for managing the various types of attribute information relating to the electronic book (content 101), and it includes such items as content ID, content name, publication start date, publication finish date, model information, billing information, author name, publisher and others.

The item of the content ID retains the ID information for uniquely identifying each content 101. In the present embodiment, for example, the file name (“A0001.tar” or the like) of the content 101 is used as the content ID (extension may be excluded from the file name). The item of the content name retains the information of the title of the content 101. The items of the publication start date and the publication finish date respectively retain the information of the start date and the finish date of a period in which the user is permitted to browse the target content 101 (publication period).

The item of the model information retains the information of the platform (for example, model, OS (Operating System) and others) of the terminal 20 capable of browsing the target content 101. More specifically, even the electronic books with the same contents are realized as plural contents 101 in some cases by the platform of the terminal 20 capable of browsing the content 101. The item of the billing information retains the information of the billing method and the money amount for the browse of the target content 101. The items of the author name and the publisher retain the information of the author and the publisher of the target content 101. Note that the above-described items of the content DB 102 are shown by way of examples, and it is a matter of course that the information may be managed by other data configuration.

FIG. 3 is a diagram showing an example of a data configuration of the member DB 103. The member DB 103 is a table for managing the account information of the users who are the members of the electronic book service provided by the electronic book system 1, and it includes such items as member ID, authentication information, SNS member information, purchased content, process history and others.

The item of the member ID retains the ID information for uniquely identifying the users who are the members. More specifically, it retains the information of the user ID when the user accesses and logs in the content server 100 from the terminal 20. The item of the authentication information retains the information for executing the user authentication (for example, password) when the target member (user) logs in the content server 100. The item of the SNS member information retains the account information which the target user has in one or more other SNS systems 31 (information of user ID/password and others capable of logging in the SNS system 31).

The item of the purchased content retains the information for specifying the content 101 which the target user purchased and can browse. For example, it retains a value of a content ID of one or more contents 101 which the user can browse. When the content 101 which the user can browse can be shared with other users (for example, when the content 101 purchased by a certain user is shared with a group of users and can be freely browsed), it may retain the information of the member ID for specifying the sharing users together. The item of the process history retains the information about the history of various processes such as the browse of the content 101 and the addition of comments carried out by accessing the content server 100 by the target user in a time-series manner. Note that the above-described items of the member DB 103 are shown by way of examples, and it is a matter of course that the information may be managed by other data configuration.

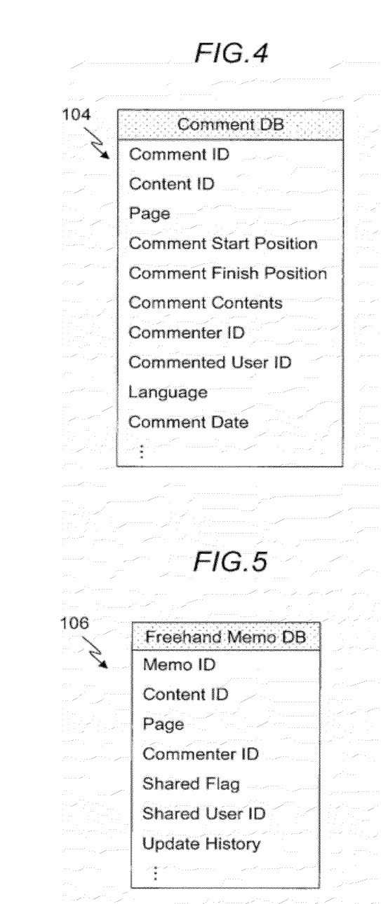

FIG. 4 is a diagram showing an example of a data configuration of the comment DB 104. The comment DB 104 is a table for retaining the information relating to the text-based comment added by the user to the content 101, and for example, it includes such items as comment ID, content ID, page, comment start position, comment finish position, comment contents, commenter ID, commented user ID, language, comment date and others.

The item of the comment ID retains the ID information for uniquely identifying the target comment. This value may be a unique value in the whole electronic book system 1 or a unique value in the content 101. The item of the content ID retains the information for specifying the content 101 to which the target comment is added.

The items of the page, the comment start position and the comment finish position respectively retain the information of the page, the start position and the finish position of the target comment added in the target content 101. When no value is assigned to these items, the target comment can be treated as being added to the whole target content 101. Also, when no value is assigned to the items of the comment start position and the comment finish position, the target comment can be treated as being added to the whole target page. The items of the comment start position and the comment finish position can be specified by, for example, the number of bites from the head in the text information of the content 101 or the target page.

The item of the comment contents retains the text information which is the main text of the target comment. The item of the commenter ID retains the information of the member ID for specifying the user who added the target comment. The item of the commented user ID retains the information of the member ID for specifying the target user when the target comment is a comment to a specific user. Note that, as the information of the target user, the information of a plurality of users may be retained and the information of a group including a plurality of users may be retained. The item of the language retains the information of the language of the target comment. The item of the comment date retains the information of the time stamp when the target comment is added. Note that the above-described items of the comment DB 104 are shown by way of examples, and it is a matter of course that the information may be managed by other data configuration.

FIG. 5 is a diagram showing an example of a data configuration of the freehand memo DB 106. The freehand memo DB 106 is a table for retaining the information relating to the freehand memo 105 added to the content 101 by the user, and it includes such items as memo ID, content ID, page, commenter ID, shared flag, shared user ID, edit history and others.

The item of the memo ID retains the ID information for uniquely identifying each freehand memo 105. In the present embodiment, for example, the file name (“B0001_U0002.gif” or the like) of the freehand memo 105 is used as the memo ID (extension may be excluded). The items of the content ID and the page respectively retain the information for specifying the content 101 and the page to which the target freehand memo 105 is added. The item of the commenter ID retains the information of the member ID for specifying the user who added the target freehand memo 105.

The item of the shared flag retains the information of the flag showing whether the target freehand memo 105 is shared with other users when the content 101 to which the target freehand memo 105 is added can be shared with other users. Also, the item of the shared user ID retains the information of the member ID for specifying the users who share the target freehand memo 105. Note that the information of plural users or the information of a group including the plural users may be retained as the information of the users who share the target freehand memo 105. The item of the update history retains the information of the update history to the target freehand memo 105 (for example, information of update time, update user and others). Note that the above-described items of the freehand memo DB 106 are shown by way of examples, and it is a matter of course that the information may be managed by other data configuration.

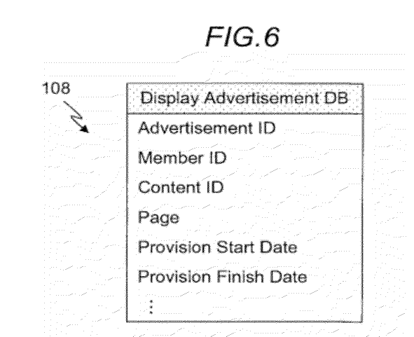

FIG. 6 is a diagram showing an example of a data configuration of the display advertisement DB 108. The display advertisement DB 108 is a table for retaining the information about where the advertisement 107 is displayed and which of the advertisements 107 is displayed when the user browses the content 101 (comment added thereto) by using the viewer 21, and it includes such items as advertisement ID, member ID, content ID, page, provision start date, provision finish date and others.

The item of the advertisement ID retains ID information for specifying the advertisement 107 to be displayed in the viewer 21. In the present embodiment, for example, the file name of the advertisement 107 is used as the advertisement ID. The item of the member ID retains the information of the member ID for specifying the user to which the target advertisement 107 is displayed. The items of the content ID and the page respectively retain the information for specifying the content 101 and the page to which the target advertisement 107 is displayed. The items of the provision start date and the provision finish date respectively retain the information of the time and date of the start and finish of a period in which the target advertisement 107 is displayed. Note that the above-described items of the display advertisement DB 108 are shown by way of examples, and it is a matter of course that the information may be managed by other data configuration.

### <Process Contents—Basic Function>

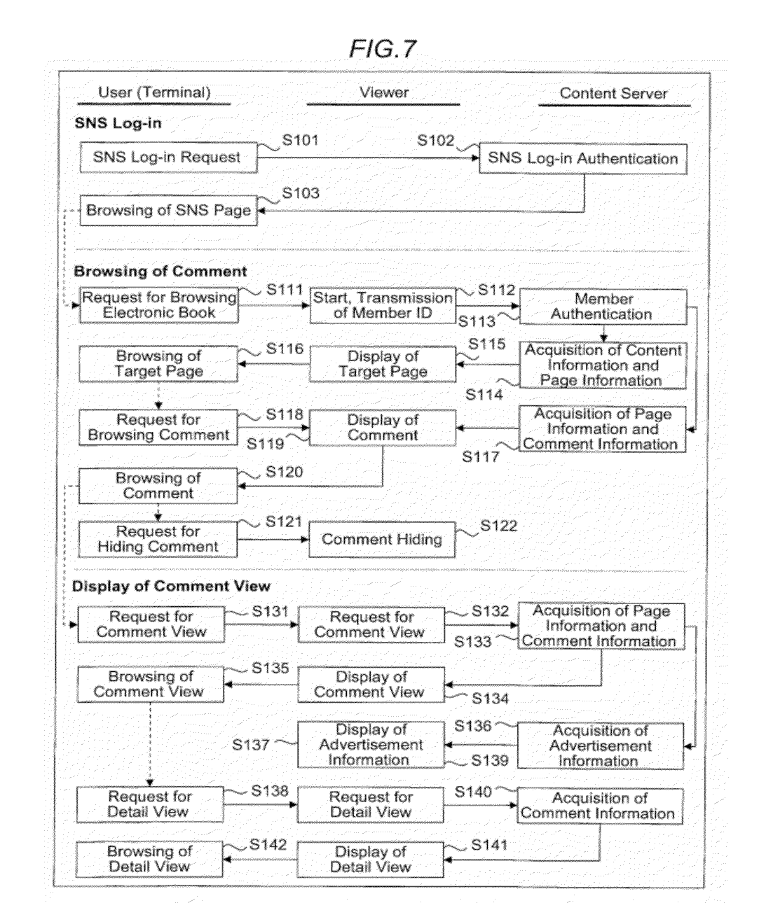

Hereinafter, the processes for realizing the basic function in the electronic book system 1 according to the present embodiment will be described. FIG. 7 is a diagram showing an example of the flow of the processes when browsing the comment added to the content 101. In advance of the browse of the comment, the user may make the log-in request to an SNS site (SNS system 31) on the terminal 20 according to need (S101).

In the content server 100 which has received the log-in request including the member ID from the terminal 20, the authentication unit 120 acquires the account information to the SNS system 31 of the user from the member ID 103, carries out the log-in authentication process to the SNS system 31 (S102), and displays the top page or the like of the user in the SNS system 31 on the terminal 20 (S103). It is also possible to guide the user to the electronic book (content 101) and the comment posting and browsing service in the electronic book system 1 by means of the comment posting and browsing function in the SNS system 31. Note that the log-in authentication to the SNS system 31 is carried out first in the example of FIG. 7, but the user can carry out the log-in authentication to the SNS system 31 at an arbitrary timing during the browse of the content 101.

The user who utilizes the browse service of the comment by the electronic book system 1 makes the browse request of the electronic book (content 101) by the selection from a menu or the like by using the terminal 20 (S111). It is also possible to enable the user to make the browse request of the content 101 through the guiding or the like from other sites such as the above-described SNS system 31. At this time, it is also possible to display the information of the content 101, which the user can browse, on the terminal 20 with reference to the information retained in the terminal 20 or the information retained in the member DB 103 of the content server 100 so as to make the user select the content 101 to be browsed based on the information.

By the browse request by the user, the terminal 20 starts the viewer 21, and upon reception of the input of the member ID and the authentication information from the user, the terminal 20 transmits these and the information of the content 101 to be browsed to the content server 100 (S112). In the content server 100, the authentication unit 120 carries out the authentication about whether the user is a member or not (user authentication) with reference to the member DB 103 (S113).

Thereafter, the reproduction processing unit 110 determines whether the user is permitted to browse the target content 101 with reference to the content DB 102, the member DB 103 and others, and when the user is permitted to browse the target content 101, the reproduction processing unit 110 acquires the contents of the content 101 and the information of the page to be displayed and transmits them to the viewer 21 (S114). By displaying the target page in the viewer 21 based on the transmitted contents (S115), the user can browse the page of the target content 101 (S116).

Furthermore, in the content server 100, for example, as the process parallel to the step S114, the comment browsing unit 132 acquires the information of the comment added to each page of the target content 101 from the comment DB 104 and transmits it to the viewer 21 (S117). When the user who is browsing the page of the content 101 makes the browse request of the comment (S118), the comment corresponding to the target page is displayed in the viewer 21 (S119), and the user can browse the comment added to the target page or others (S120). Also, the user can make a request for hiding the comment (S121). At this time, the viewer 21 hides the comment (S122).

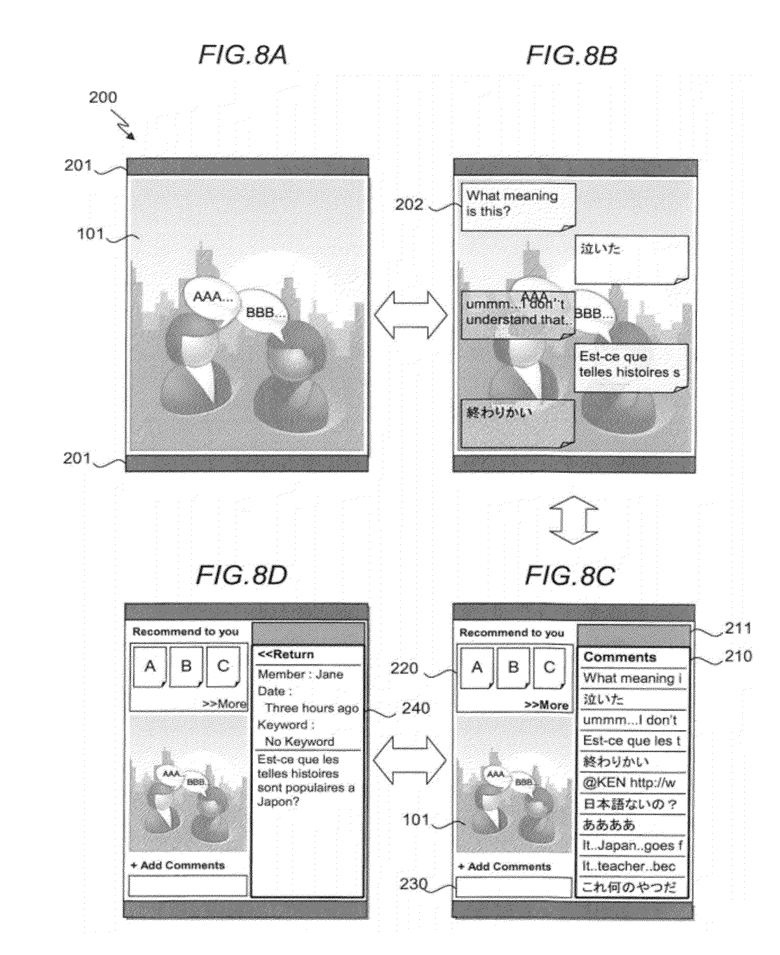

FIG. 8 is a diagram showing examples of screens when displaying the content 101 and the comment in the viewer 21. FIG. 8A shows an example in which a page of the content 101 is displayed on a screen 200 in the viewer 21. Here, in the present embodiment, the case in which the content 101 is displayed on a mobile terminal having a touch panel such as the so-called smart phone is taken as an example. On the screen, for example, menu regions 201 in which various menus and buttons by which the user operates the viewer 21 are displayed are provided in upper and lower parts of the screen.

For example, the viewer 21 displays the comment added to the target page according to the instruction from the user through the menu region 201 as shown in FIG. 8B. Here, when displaying the comment, for example, a comment layer which can display the comment with a transparent format is displayed on the target page, and the comments added by each user are respectively displayed in a plurality of comment display regions 202 in the comment layer. Also, by hiding the comment layer of the target page according to the instruction from the user through the menu region 201, the comment is hidden as shown in FIG. 8A.

Returning back to FIG. 7, in a state of browsing the comment added to the target page on the screen as shown in FIG. 8B, the user can make a request for browsing a comment view by which the user can reference various types of information relating to each comment added to the target page (S131). The viewer 21 transmits the display request of the comment view to the content server 100 (S132). The content server 100 acquires the information of each comment added to the target page from the comment DB 104 by the comment browsing unit 132 and transmits it to the viewer 21 (S133). By displaying the comment view based on the transmitted contents in the viewer 21 (S134), the user can browse the comment view (S135).

Note that, in the content server 100, when the comment browsing unit 132 acquires the information of each comment and transmits it to the viewer 21 in the step S133, the advertisement processing unit 140 extracts the information of other electronic book (content 101) recommended for the user and the information of the target advertisement 107 (advertisement 107) and transmits them to the viewer 21 (S136). The viewer 21 displays the recommended electronic book and the target advertisement in the comment view based on the transmitted contents (S137).

In the step S136, the advertisement processing unit 140 carries out the analysis by the language processing based on the contents of the comment displayed in the viewer 21 by the comment browsing unit 132 and the text information of the target content 101, the page and the keyword, and extracts one or more keywords. By performing the matching between this keyword and the keyword given to the content 101 and the advertisement 107, the page in which the content 101 is recommended, the content 101 to be recommended and the advertisement 107 to be displayed can be determined.

Note that, in addition to the matching by the text information, the recommended electronic book and advertisement can be determined based on the information such as the attribute and the process history (action history) of the target user retained in the member DB 103 and others. Also, if the corresponding content 101 and advertisement 107 are not present, they can be determined based on a predetermined rule such as an order of arrival. Also, these kinds of information can be prepared and retained in advance in the display advertisement DB 108 by the periodical process in the advertisement processing unit 140 and the registration by the administrator of the electronic book system 1.

The user can make a request for browsing a comment detail view that can reference the detail of the arbitrary comment selected from the comment view (S138). The viewer 21 transmits a request for displaying the comment detail view together with the information such as the comment ID and others of the selected comment to the content server 100 (S139). In the content server 100, the comment browsing unit 132 acquires the detail information of the target comment from the comment DB 104 and transmits it to the viewer 21 (S140). By displaying the comment detail view based on the transmitted contents in the viewer 21 (S141), the user can browse the comment detail view (S142).

FIG. 8C is a diagram showing an example of the screen in the case of displaying the comment view. In the example of FIG. 8C, the content 101 is displayed in a reduced size, and a list of the comments added from the plural users to the target page and others is displayed in a time-series manner in a comment list region 210. The information may be periodically and automatically refreshed to acquire the latest information or manually refreshed. For example, a menu region 211 is provided in the upper part of the comment list region 210 to enable the various operations (for example, keyword search) to the comment by the user. Furthermore, the information of the recommended book is displayed as the content 101 recommended for the user in an advertisement display region 220. A comment input region 230 in which the comment can be input and added is also provided.

For example, by the instruction from the user through the menu region 211, the viewer 21 displays the detail contents of the comment selected by the user by the comment detail view as shown in FIG. 8D. In the comment detail view, for example, the contents of each item for the target comment retained in the comment DB 104 are displayed in a comment display region 240. Furthermore, such operations of sending a comment reply to the target comment and adding a new comment by quoting the target comment can be performed. Note that the information relating to the reply and the quotation in the added comment can be directly embedded in, for example, the text information of the comment.

In the example mentioned above, the example in which the content 101 and the comment are displayed with using the mobile terminal as the terminal 20 has been described, but the case in which the same user browses the same purchased content 101 by using another terminal 20 such as the PC is also assumed. In this case, the file format sometimes differs depending on the platform of the terminal 20, and the content server 100 includes individual contents 101 for each platform of the terminals 20 in some cases.

In the present embodiment, the comment is separated from the content 101 and retained as text information in the comment DB 104 in the content server 100. Therefore, even in the case as described above, the difference in platform of the terminal 20 is absorbed by the corresponding viewer, and the comment added in the viewer 21 of a certain terminal 20 can be similarly displayed also in the viewer 21 of the terminal 20 with another platform.

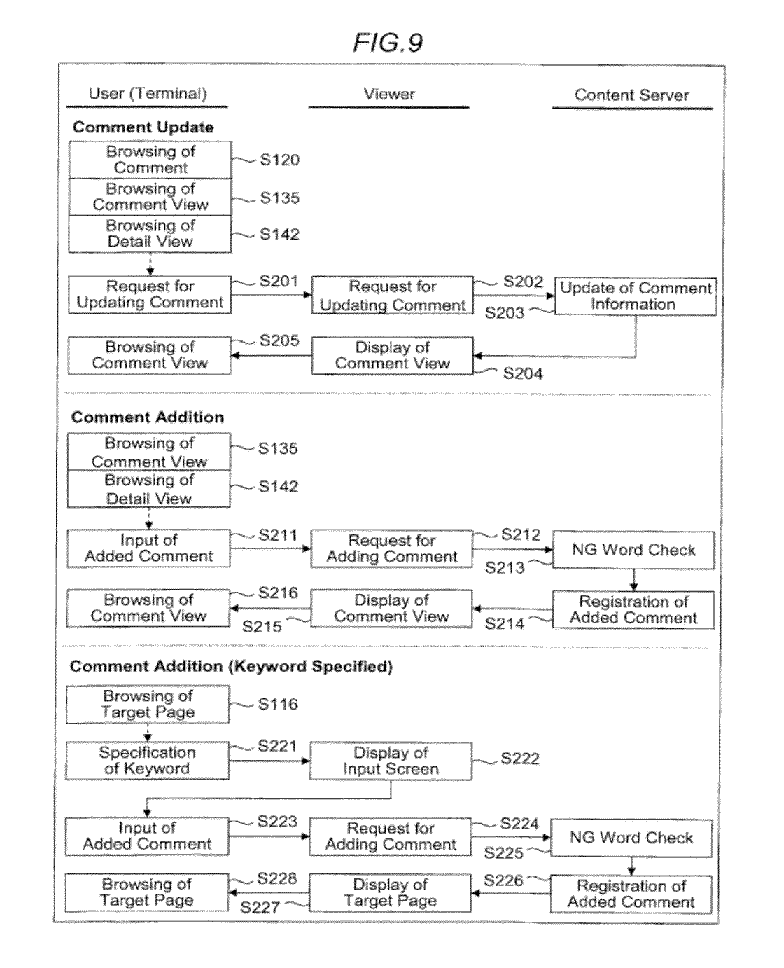

FIG. 9 is a diagram showing an example of the flow of the processes when updating and adding the comment to the content 101. For example, in a state of browsing the comment added to the target page on the screen as shown in FIG. 8B to FIG. 8D, the user can make an update request to the comment by selecting the comment added by himself/herself and inputting the updating contents of the comment (S201). The viewer 21 transmits the update request including the comment ID of the target comment and the updating contents to the content server 100 (S202). In the content server 100, the comment registration unit 131 updates the contents of the target comment in the comment DB 104 and acquires the information of the updated comment to transmit it to the viewer 21 (S203). By displaying the comment view and others based on the transmitted contents in the viewer 21 (S204), the user can browse the comment view and others including the updated comment (S205).

Furthermore, for example, in a state of browsing the comment added to the target page on the screen as shown in FIG. 8C and FIG. 8D, the user can add the comment to the target page by inputting the comment to the comment input region 230 (S211). The viewer 21 transmits the comment addition request including the information of the contents of the added comment and the target content 101 and page to the content server 100 (S212).

In the content server 100, the comment registration unit 131 checks whether an NG word which is an inappropriate word is contained in the comment (S213). When no NG word is contained, after the comment ID is obtained and the added comment is registered in the comment DB 104, the information of the comment after the registration is acquired and transmitted to the viewer 21 (S214). By displaying the comment view and others based on the transmitted contents in the viewer 21 (S215), the user can browse the comment view and others including the added comment (S216).

Note that it is also possible to add a comment to a specific user when adding the comment. For example, by inserting the words of “@[member ID of specific user]” at the head of the comment, the comment can be directed only to the specific user. Note that the method of specifying the specific user is not limited to that described above, and other methods can be applied as long as the information of the specific user (or plural users or group) can be retained in association with the comment.

Furthermore, for example, in a state of browsing the target page on the screen as shown in FIG. 8A, the user selects a range specified as a keyword in the text information in order to add the comment to the arbitrary comment in the text information in the page (S221). The viewer 21 which has received the information of the range specified as the keyword displays a screen for inputting the comment (S222). The user can add the comment to the target keyword by inputting the comment in the screen for inputting the comment (S223).

The viewer 21 transmits a request for adding a comment including the information of the contents of the added comment, the target content 101 and the range specified as the keyword to the content server 100 (S224). In the content server 100, the comment registration unit 131 checks whether an NG word is contained in the comment (S225), obtains a comment ID to register the added comment to the comment DB 104, and acquires the information of the comment after the registration to transmit it to the viewer 21 (S226). By displaying the target page based on the transmitted contents in the viewer 21 (S227), the user can browse the page including the information of the added comment (S228).

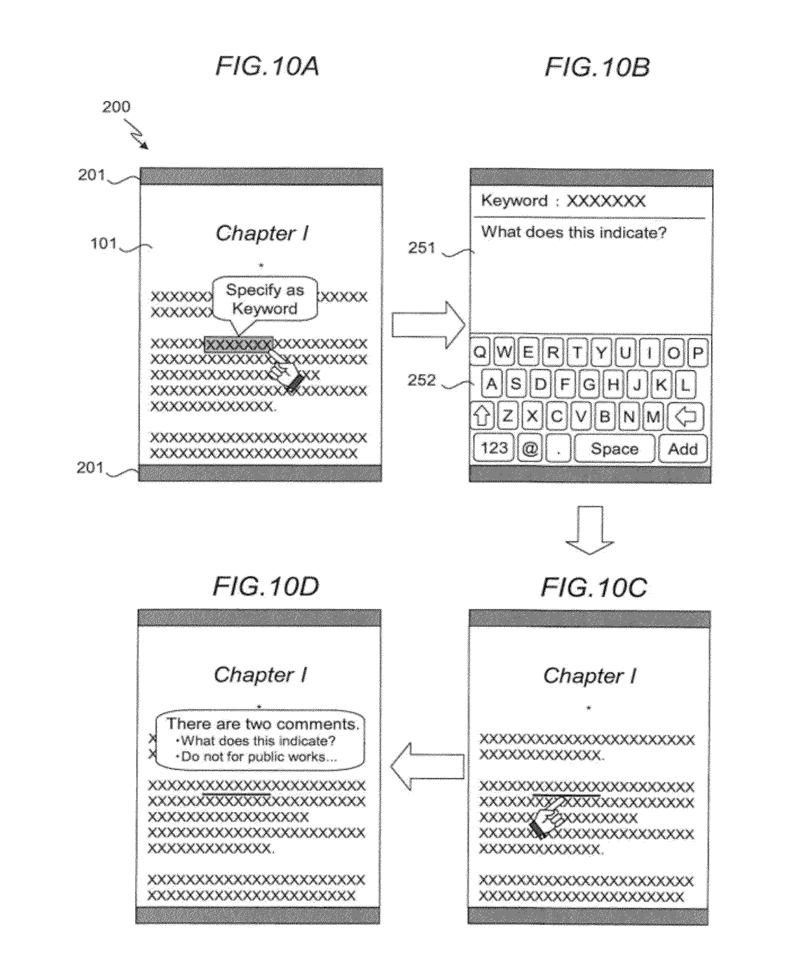

FIG. 10 is a diagram showing an example of the screen when adding the comment to the keyword of the content 101 in the viewer 21 in the step S221 in FIG. 9. FIG. 10A is a diagram showing an example of the screen when specifying a range of the target keyword to which the comment is added. As shown in FIG. 10A, for example, the range of the word specified as the keyword is selected in the manner of the range specification of the text edit, and by the interface of clicking the pop-up “specify as keyword” or the like, the words included in the specified range are selected as the keyword.

The keyword is not specified as the word, but is specified by, for example, the number of bites from the head of the content 101 or the page. By this means, even when there are the same words and phrases in the content 101, the case in which the word or phrase to which the comment is added is uncertain can be avoided. Also, for example, even when a plurality of phrases including the word at the same position are specified as keywords, these can be individually specified.

Note that the specification of the range of the keyword may be carried out after the transition to the mode for specifying the range of the keyword by making an instruction to specify the keyword and add the comment from the menu region 201 during the browse of the page, or it may be carried out by specifying the range of the text information during the browse of the page and then making an instruction to add the comment to the specified range from the menu region 201, the pop-up and others.

FIG. 10B is a diagram showing an example of the screen for inputting the comment to the selected keyword in the step S223 in FIG. 9. For example, the comment can be input to a comment input region 251 by using a software keyboard 252 and others.

FIG. 10C is a diagram showing an example of the screen when displaying the page of the content 101 in which the comment is added to the keyword. For example, it is displayed by drawing a line under the keyword to which the comment is added. Note that, for example, when a plurality of phrases including the word at the same position are specified as keywords, they can be distinguished by drawing two underlines or the like. By selecting the underlined part by clicking or the like, the list of the comments added to the corresponding keyword is displayed by the pop-up or the like as shown in FIG. 10D. It is also possible to make a transition from this pop-up to the comment view and the comment detail view shown in FIG. 8C and FIG. 8D based on the instruction from the user.

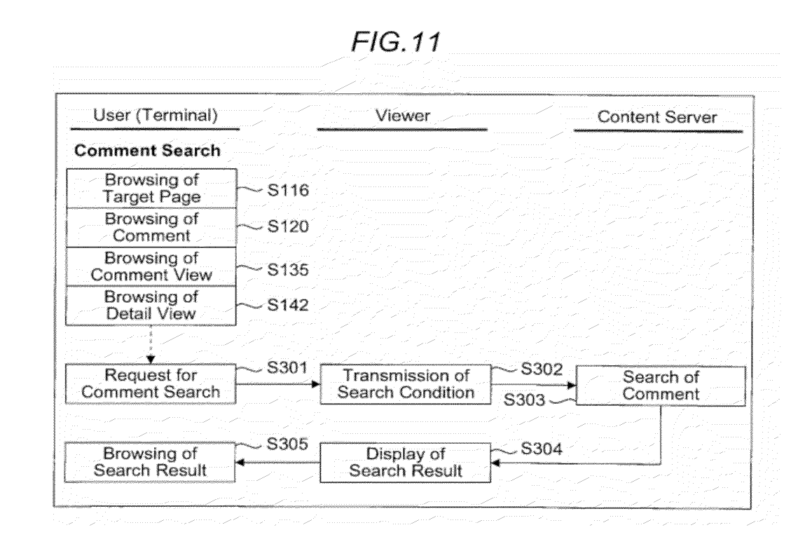

FIG. 11 is a diagram showing an example of the flow of the processes when searching and browsing the comment added to the content 101. For example, in a state of browsing the target page or the comment added to the target page on the screen as shown in FIG. 8A to FIG. 8D, the user can make a request for searching the keyword by specifying the search condition (S301). The viewer 21 transmits the information of the content 101 and the page and the information including the specified search condition to the content server 100 (S302). In the content server 100, the comment browsing unit 132 acquires the comment including the keyword specified as the search condition out of those added to the target page from the comment DB 104 and transmits it to the viewer 21 (S303). By displaying the information of the transmitted search result in the viewer 21 (S304), the user can browse the search result and narrow down comment (S305).

Here, as described above, by inserting the words of “@[member ID of specific user]” at the head of the comment, the comment can be directed only to the specific user in the present embodiment. Therefore, for example, by automatically or manually specifying “@[own member ID]” as the search condition, the comments directed to the user himself/herself can be extracted. Furthermore, by retaining the information of the time stamp in the previous search process in the terminal 20 and transmitting it together when transmitting the search conditions and the like in the viewer 21 to the content server 100, only the new comment added after the previous search process can be extracted as the search result.

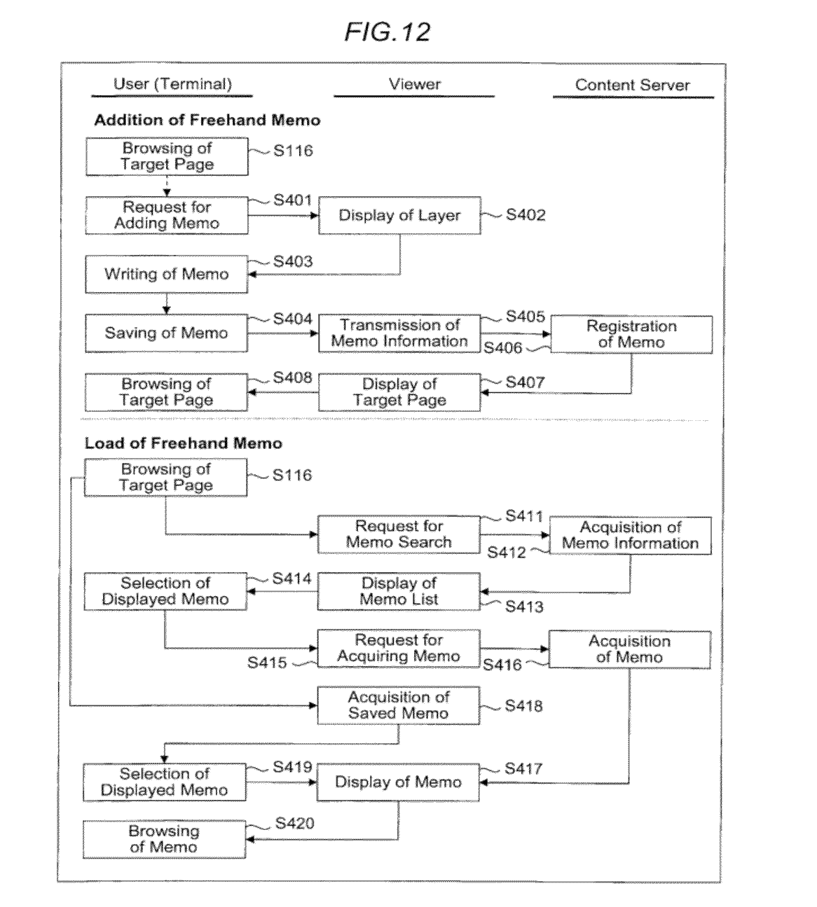

FIG. 12 is a diagram showing an example of the flow of the processes when adding the freehand memo to the page of the content 101. For example, in a state of browsing the target page on the screen as shown in FIG. 8A, the user can make a request for adding the freehand memo to the target page (S401). At this time, the viewer 21 displays a new layer for drawing the freehand memo capable of being displayed with a transparent format on the target page (S402). The user writes the memo to this layer by a handwriting input (S403) and saves it (S404).

As the destination to save the freehand memo, the (storage device of) terminal 20 or the content server 100 can be selected. When the freehand memo is saved in the terminal 20, the freehand memo can be browsed only when the content 101 is browsed by using the terminal 20. On the other hand, when the freehand memo is saved in the content server 100, the freehand memo can be shared with the terminal 20 with another platform and the other specified users. Similarly to the comment by the text, the sharing with other users includes the sharing among the users who purchase the target content 101 and can browse it and the sharing of the target content 101 itself (case of sharing and browsing the same content 101 with a plurality of users).

When the freehand memo is saved in the content server 100, the viewer 21 transmits the information of the target page of the content 101 and the contents of the freehand memo (image file data displayed as layer) (S405). Whether the freehand memo is shared with other users or not and the information of the target users when sharing the freehand memo are also transmitted together. In the content server 100, the comment registration unit 131 retains the image file data of the freehand memo as the freehand memo 105, registers the contents in the freehand memo DB 106, and acquires the information of the freehand memo 105 after the registration to transmit it to the viewer 21 (S406). By displaying the target page based on the transmitted contents in the viewer 21 (S407), the user can browse the page including the added freehand memo 105 (S408).

Note that, in the content server 100, by naming the file of the freehand memo 105 as “content ID+member ID” (for example, “B0001_U0002.gif), the content 101 and the user can be associated with the freehand memo 105.

Also, for example, when browsing the target page on the screen as shown in FIG. 8A, the user can load the freehand memo 105 added to the target page. When the user browses the target page, the viewer 21 makes a request for searching the freehand memo 105 saved in the content server 100 or shared with other users (S411). In the content server 100, the comment browsing unit 132 acquires the information of the freehand memo 105 saved by the target user or the freehand memo 105 shared with other users with reference to the freehand memo DB 106 and transmits it to the viewer 21 (S412).

The viewer 21 displays the transmitted information of the list of the freehand memo 105 (S412). The user can select one or more freehand memos to be displayed from the list of the freehand memo 105 (S414). The viewer 21 transmits the request for acquiring the data including the information for specifying the selected freehand memo 105 to the content server 100 (S415). In the content server 100, the comment browsing unit 132 acquires the data of the corresponding freehand memo 105 with reference to the freehand memo DB 106 and transmits it to the viewer 21 (S416). By displaying the target page and the layer of the freehand memo 105 based on the transmitted contents in the viewer 21 (S417), the user can browse the page including the selected freehand memo 105 (S420).

On the other hand, when the user browses the target page, the viewer 21 acquires and displays the information of the list of the freehand memo saved in the terminal 20 (S418). The user can select one or more freehand memos to be displayed from the list of the freehand memo (S419). By displaying the target page and the layer of the selected freehand memo in the viewer 21 (S417), the user can browse the page including the selected freehand memo 105 (S420). Note that it is also possible to carry out the process from the steps S411 to S413 and the process of the step S418 in parallel so as to display the list of the freehand memo 105 saved in the content server 100 and the freehand memo saved in the terminal 20 together, thereby making the user select the freehand memo.

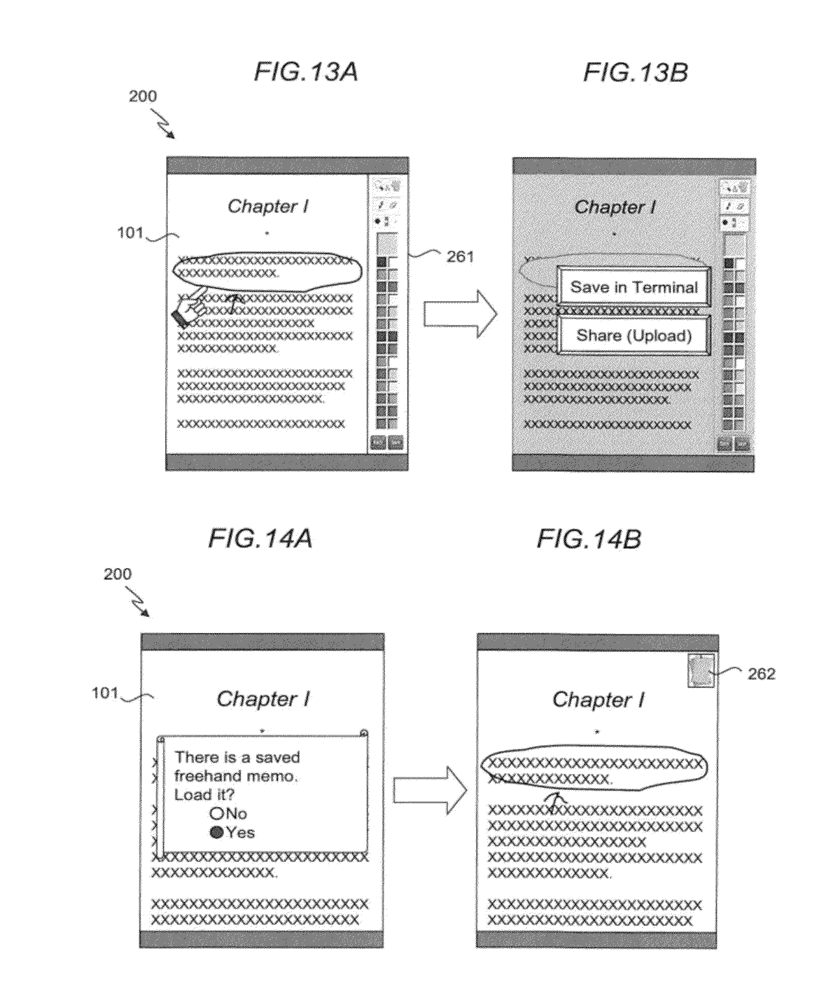

FIG. 13 is a diagram showing an example of the screen when adding the freehand memo to the page of the content 101 in the viewer 21. When displaying the layer to write the freehand memo in the step S402 in FIG. 12, the viewer 21 displays a drawing tool 261 together as shown in FIG. 13A. The user can freely handwrite a memo by using the drawing tool 261 as shown in FIG. 13A.

Here, when the user carries out the save of the freehand memo in the step S404 in FIG. 12, the viewer 21 displays the specification screen of the save destination as shown in FIG. 13B so as to make the user select whether to save the freehand memo in the terminal 20 or to upload and save it in the content server 100. When the save in the content server 100 is selected, the viewer 21 can make the user specify whether the sharing with other users is permitted or not and the users to share the freehand memo when the sharing is permitted. Note that, when the target content 101 itself is shared with other users, the above-described specification about the sharing can be carried out by only the users who purchased the corresponding content 101.

FIG. 14 is a diagram showing an example of the screen when displaying the freehand memo saved in the terminal 20 in the viewer 21. When there is the freehand memo saved in the terminal 20 in the step S418 in FIG. 12, the viewer 21 displays a confirmation screen as shown in FIG. 14A, thereby making the user select whether the freehand memo is loaded and displayed. When a plurality of freehand memos are saved, a selection screen may be displayed.

When the user selects to load and display the freehand memo, the viewer 21 loads the file of the target freehand memo from the terminal 20 in the step S417 in FIG. 12, and displays it on the content 101 as a layer of a transparent format as shown in FIG. 14B. Note that it is also possible to browse the freehand memo only when necessary by providing a display switching button 262 in FIG. 14B for switching the show/hide of the displayed freehand memo.

From the display screen of the freehand memo as shown in FIG. 14B, the viewer 21 further displays a writing screen of the freehand memo as shown in FIG. 13A based on the instruction from the user. By this means, the user can update the contents of the existing freehand memo.

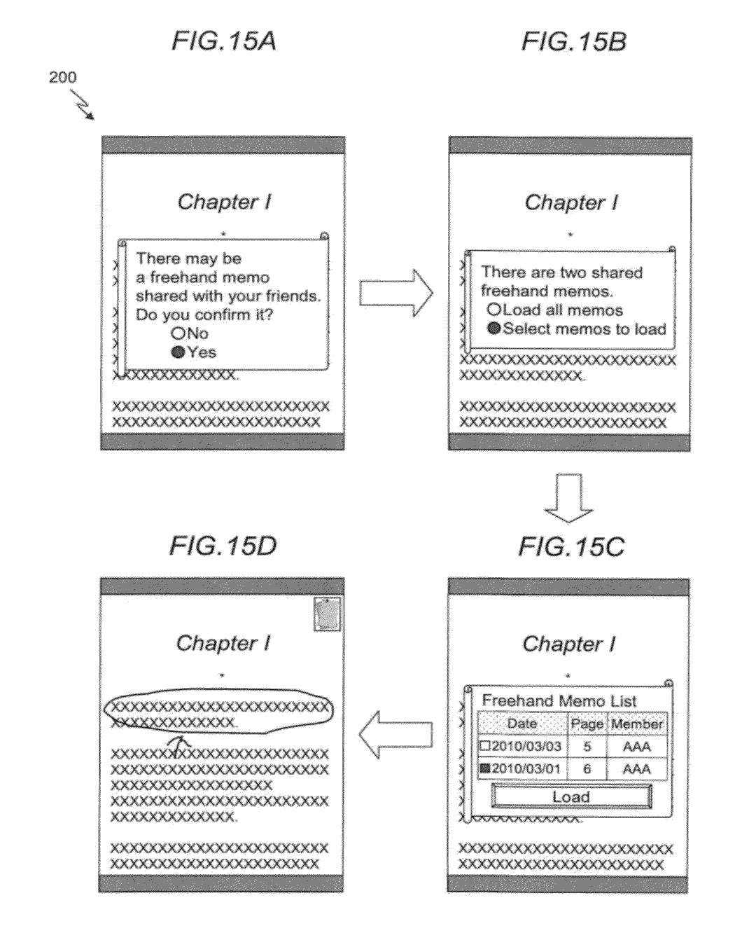

FIG. 15 is a diagram showing an example of the screen when displaying the freehand memo 105 saved in the content server 100 in the viewer 21. When searching the freehand memo 105 saved and shared in the content server 100 in the step S411 in FIG. 12, the viewer 21 makes a confirmation with the user by displaying the screen as shown in FIG. 15A. By this means, the user can skip the unnecessary access to the content server 100 when it is not necessary to browse the freehand memo 105.

Thereafter, when the viewer 21 displays the information of the list of the freehand memo 105 in the step S413 in FIG. 12, the viewer 21 displays a confirmation screen as shown in FIG. 15B and a selection screen including the list of the freehand memo 105 as shown in FIG. 15C, thereby making the user select the freehand memo 105 to be displayed. Then, the viewer 21 displays the selected freehand memo 105 as shown in FIG. 15D in the step S417 in FIG. 12. Note that the exclusive control in which the freehand memo is displayed by the read-only mode for the other users while one of the sharing users is updating the corresponding freehand memo 105 in the comment browsing unit 132 of the content server 100 is desirably applied to the freehand memo 105 shared with other users.

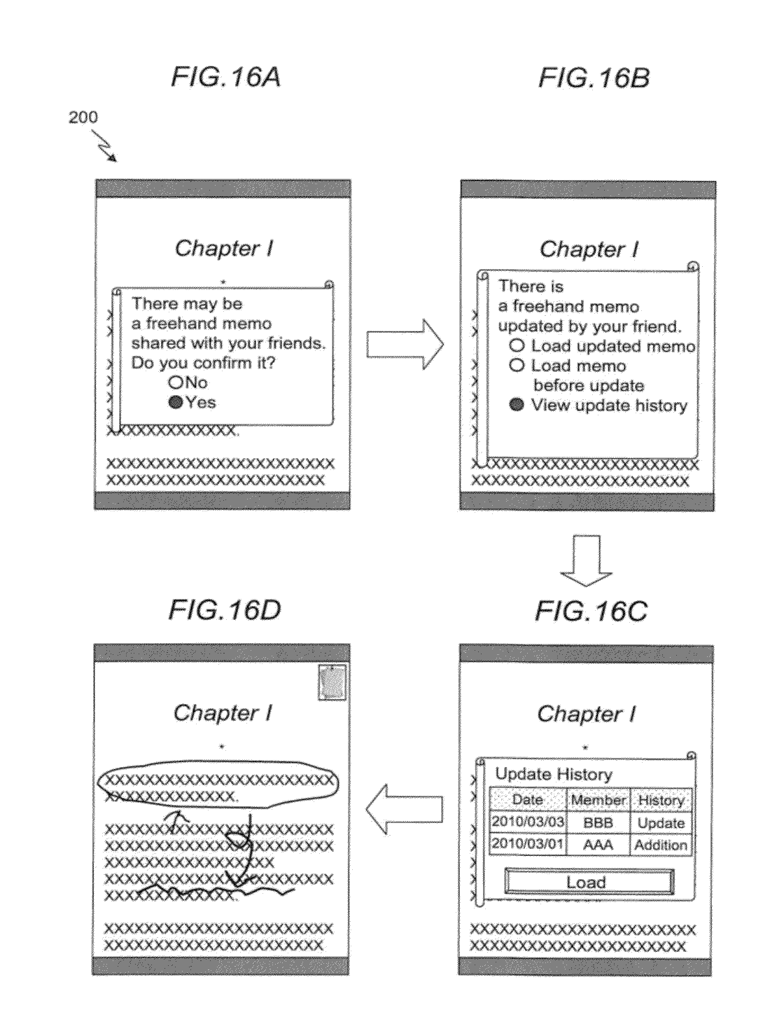

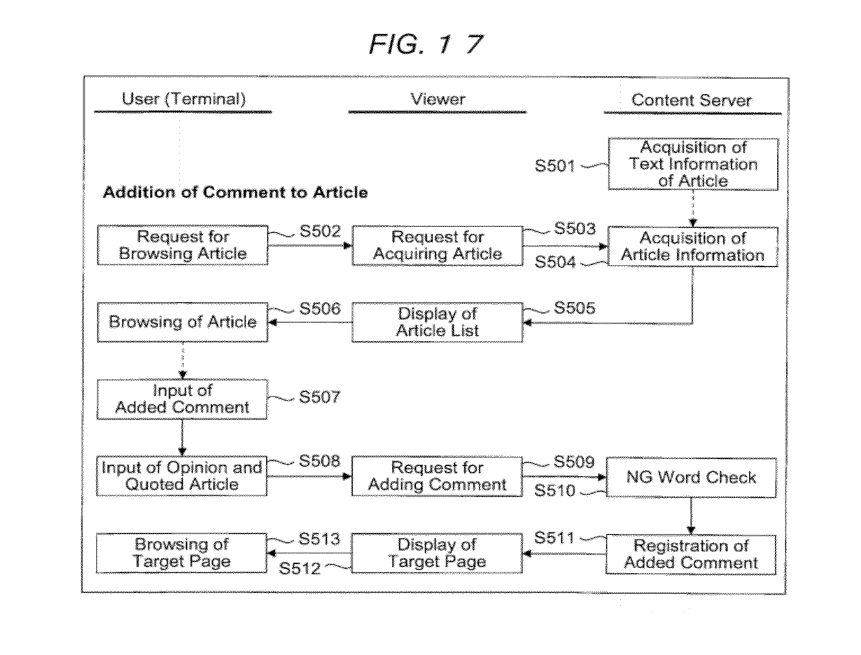

FIG. 16 is a diagram showing another example of the screen when displaying the freehand memo 105 saved in the content server 100 in the viewer 21. Similarly to the case of FIG. 15, when browsing the freehand memo 105 saved and shared in the content server 100 in the step S411 in FIG. 12, the viewer makes a confirmation with the user by displaying the screen as shown in FIG. 16A.

Here, when the freehand memo 105 added and saved by himself/herself in the content server 100 and shared with other users is updated by the other user, the viewer 21 displays a confirmation screen as shown in FIG. 16B and a confirmation screen including the information of the update history as shown in FIG. 16C. By this means, the user is made to select whether the original freehand memo 105 before the update is displayed or the freehand memo 105 after the update by the other user is displayed. Then, the viewer 21 displays the selected freehand memo 105 as shown in FIG. 16D in the step S417 in FIG. 12.

Note that the update history of the freehand memo 105 may be retained in the freehand memo DB 106 or may be added as the comment to the target content 101. Furthermore, in the content server 100, by naming the freehand memo 105 after the update as “content ID+member ID+member ID of updater+serial number” (for example, “B0001_U0002_U0003_{—}001.gif”) when the freehand memo 105 is updated by the other user, the freehand memo 105 before the update and the freehand memo 105 after the update (including the plural updates by the same user) can be individually retained in association with each other.

### <Process Contents—Advanced Function>

Hereinafter, the processes for realizing the various advanced functions in the electronic book system 1 according to the present embodiment will be described. FIG. 17 is a diagram showing an example of the flow of the processes when adding the comment to the content 101 (electronic article) such as newspaper article and news. First, if the text information of the article of the content 101 can be acquired, the content server 100 acquires and retains the information as the text information attached to the content 101 in advance (S501). For example, when the text information is attached to the content 101, it can be used. Alternatively, the information may be acquired through the conversion of the electronic article to the text article by means of various character recognition technologies.

The user makes a request for browsing the article (content 101) by using the terminal 20 (S502). The viewer 21 transmits a request for acquiring the list (article list) of the content 101 to the content server 100 (S503). In the content server 100, the reproduction processing unit 110 determines whether the user is permitted to browse the content 101 with reference to the content DB 102, the member DB 103 and others, and when the user is permitted to browse the content 101, the reproduction processing unit 110 acquires the information of the list of the content 101 and transmits it to the viewer 21 (S504). By displaying the list of the content 101 in the viewer 21 based on the transmitted contents (S505), the user can select and browse the target content 101 (S506).

Here, similarly to the steps S211 to S216 and the steps S221 to 228 of the processes of adding the comment shown in FIG. 9, the user can add the comment of the text information to the content 101 and the page, frame and keyword thereof. At this time, when the comment is added in each content 101 (article) (S507), the user can set the opinion (stance) to the article and quote the past article (S508). By these means, the user can have highly concentrated discussion and exchange of opinions. Since the process of the steps S509 to S513 is the same as that of the steps S212 to S216 of FIG. 9, the description thereof is omitted.

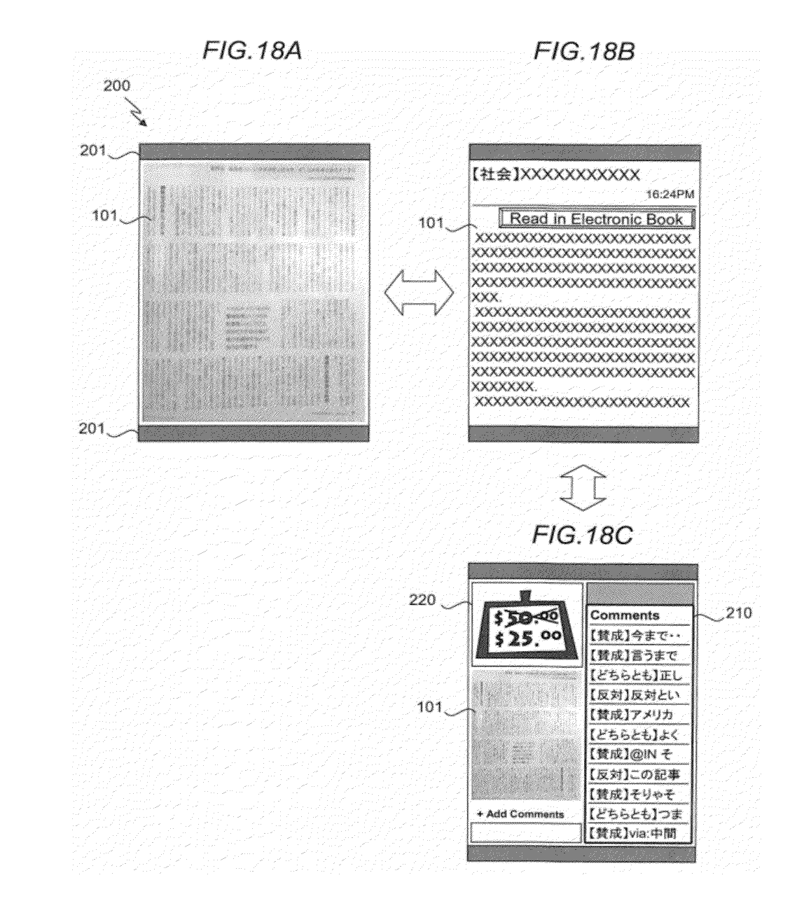

FIG. 18 is a diagram showing an example of the screen when displaying the content 101 of the electronic article and the comment in the viewer 21. FIG. 18A shows an example in the case in which the viewer 21 displays the page of the content 101 of the electronic article. Here, the viewer 21 displays the text information of the target content 101 acquired in the step S501 in FIG. 17 as the text article as shown in FIG. 18B by the instruction and others from the user through the menu region 201. The display of the electronic article in FIG. 18A and the display of the text article in FIG. 18B can be appropriately switched.

FIG. 18C is a diagram showing an example of the screen when displaying the comment view for the article. In the example of FIG. 18C, similarly to the comment view shown in FIG. 8C, the content 101 (article) is displayed in a reduced size, and a list of the comments added from the plural users to the target article is displayed in a time-series manner in the comment list region 210. Furthermore, for example, the advertisement 107 determined by the advertisement processing unit 140 of the content server 100 is displayed as the target advertisement to the user in the advertisement display region 220.

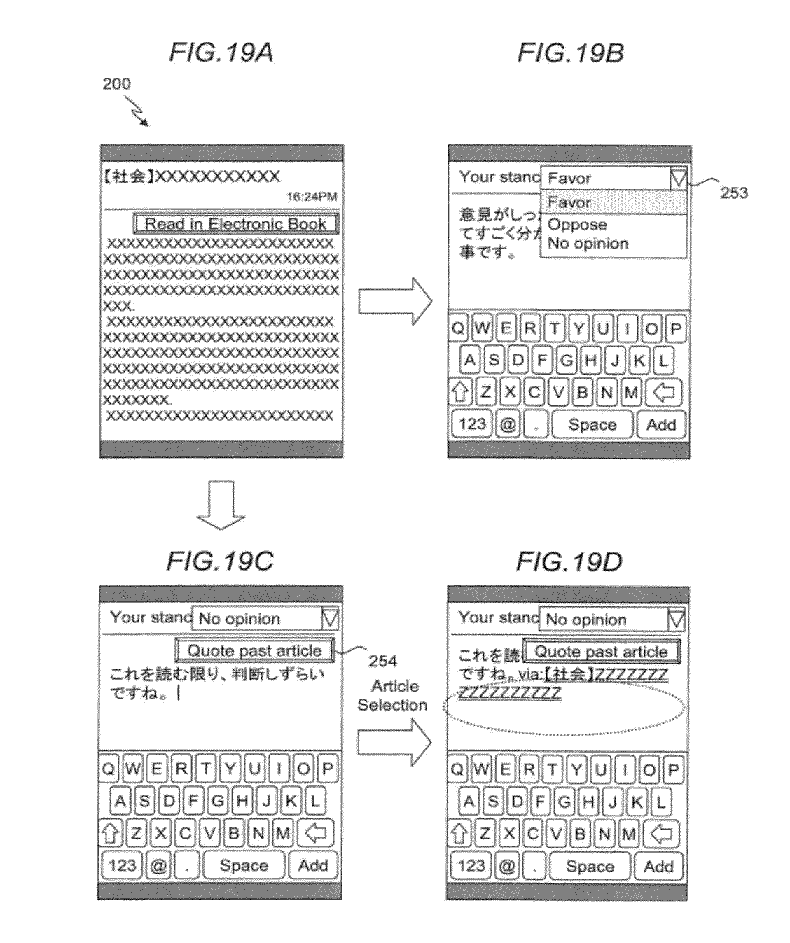

FIG. 19 is a diagram showing an example of the screen when adding the comment to the content 101 of the electronic article in the viewer 21. FIG. 19A shows an example in the case in which the target content 101 is displayed as the text article similarly to the case of FIG. 18B. Furthermore, FIG. 19B shows an example in the case in which an opinion is set and a comment is added to the content 101 in the steps S507 and S508 in FIG. 17. Here, an opinion setting portion 253 is further provided in the input screen to add the comment similar to that of FIG. 10B.

By this opinion setting portion 253, the user can set an opinion (stance) to the target content 101 (article). The set opinion may be retained in, for example, the comment DB 104 of the content server 100 or may be inserted and retained in the comment itself in the form of “@opinion=favor” or the like. In this manner, the collection of the neutral evaluations to the target article and the share and exchange of the opinions become possible. Furthermore, by accumulating the opinions from each of the users, the useful marketing data in the recommendation and the target advertisement to the users can be obtained.

Note that, in the example of FIG. 19, the opinion is selected from “favor”, “oppose” and “no opinion”, but the choice of opinion is not limited to this, and various types such as “satisfied” and “dissatisfied” can be set depending on the contents of the article. The information can be set in, for example, the content DB 102 in advance.

Furthermore, FIG. 19C shows an example in the case in which the comment is added to the content 101 by quoting the past article in the steps S507 and S508 in FIG. 17. Here, in the input screen to add the comment similar to that of FIG. 19B, the user presses a past article button 254, and the viewer 21 displays a screen showing an article list (not shown). Here, when the user selects the article to be quoted, a link to the selected article is inserted in the comment as shown in FIG. 19D. In this manner, highly concentrated discussion and exchange of opinions more associated with the topic of the article become possible.

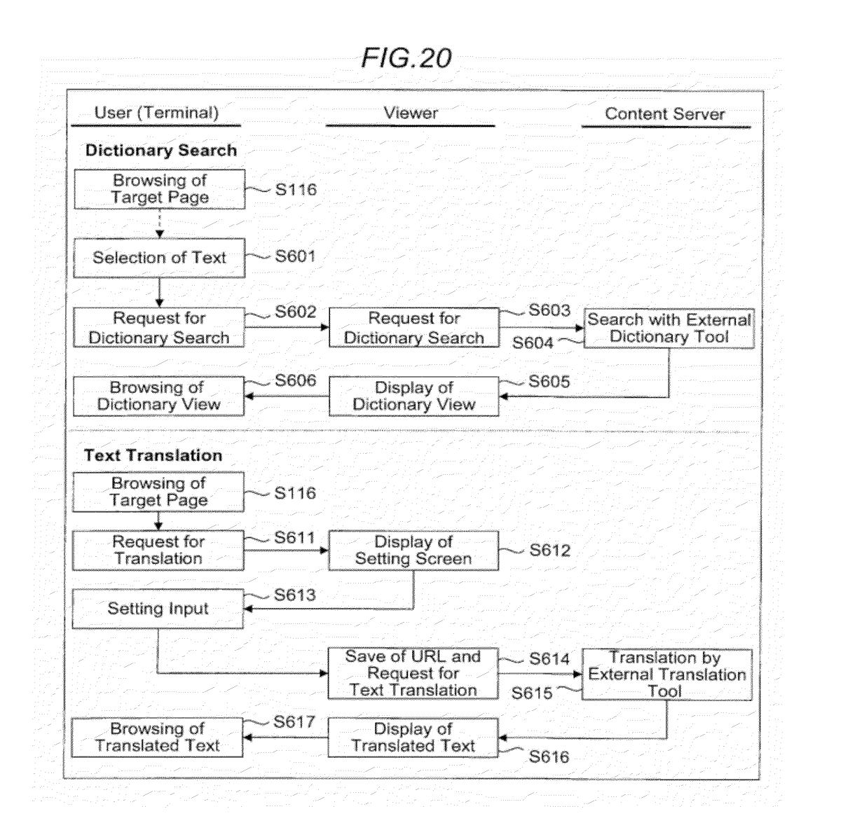

FIG. 20 is a diagram showing an example of the flow of the processes when the keyword of the content 101 is searched with a dictionary and when the text information of the content 101 is translated and browsed. For example, when browsing the target page on the screen as shown in FIG. 10C, the user selects the range to be specified as the keyword of the dictionary search in the text information in the page (S601) and makes a request for the dictionary search (S602). The viewer 21 transmits the request of the dictionary search including the selected keyword to the content server 100 (S603). In the content server 100, the dictionary search unit 151 searches the keyword by using the external dictionary tool 33 and others and transmits the information of the search result to the viewer 21 (S604). By displaying a dictionary view based on the transmitted contents in the viewer 21 (S605), the user can browse the result of the dictionary search (S606).

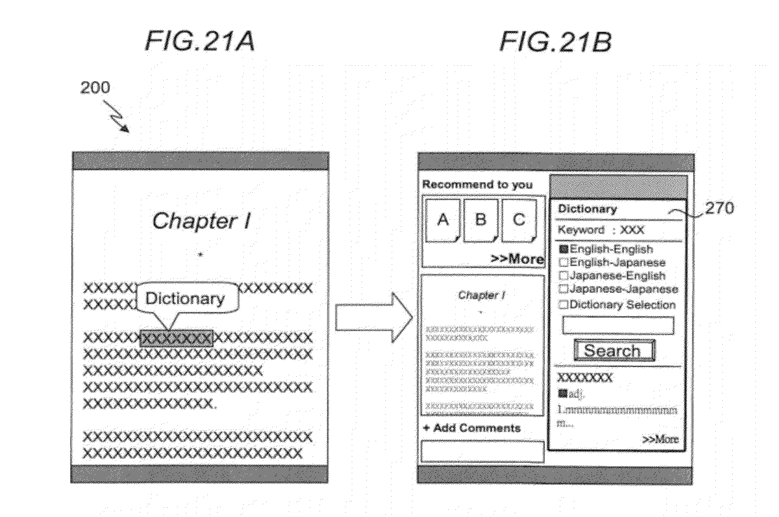

FIG. 21 is a diagram showing an example of the screen when searching the keyword of the content 101 with a dictionary in the viewer 21. FIG. 21A is a diagram showing an example of the screen when specifying the range of the keyword of the dictionary search in the step S601 in FIG. 20. Here, it can be specified by the same interface as that used in the keyword specification in adding the comment to the keyword. As shown in FIG. 21A, for example, the range of the words specified as the keyword is selected in the manner of the range specification of the text edit, and the pop-up “dictionary” is clicked. By this means, the word included in the specified range is selected as the keyword and the dictionary search using the keyword can be carried out. Similarly to the case of adding the comment, the selected keyword is specified by, for example, the number of bites from the head of the content 101 or the page.

FIG. 21B is a diagram showing an example of the screen when displaying the dictionary view showing the result of the dictionary search. Here, a dictionary region 270 is displayed in place of the comment list region 210 in the same screen as the comment view as shown in FIG. 8C. In the dictionary region 270, in addition to the browse of the result of the dictionary search, for example, operations such as the selection of the type of the dictionary to be used and the full-screen display of the dictionary region 270 can be carried out.

Returning back to FIG. 20, when browsing the content 101 on the screen as shown in FIG. 10C, the user can make a request for translating the text information of the content 101 (S611). When the user makes a request for the translation, the viewer 21 displays a setting screen for making settings of the translation (S612). When the user inputs the settings of the translation on the setting screen (S613), the viewer 21 saves URL (Uniform Resource Locator) of the translation source (external translation tool 34) in the settings of the translation and transmits a text translation request including the information of the target content 101 and the settings of the translation to the content server 100 (S614).

In the content server 100, the translation unit 152 translates the text information of the target content 101 by using the external translation tool 34 and others and transmits the text information after the translation to the viewer 21 (S615). By displaying the text information after the translation based on the transmitted contents in the viewer 21 (S616), the user can browse the text information after the translation to the content 101 (S617).

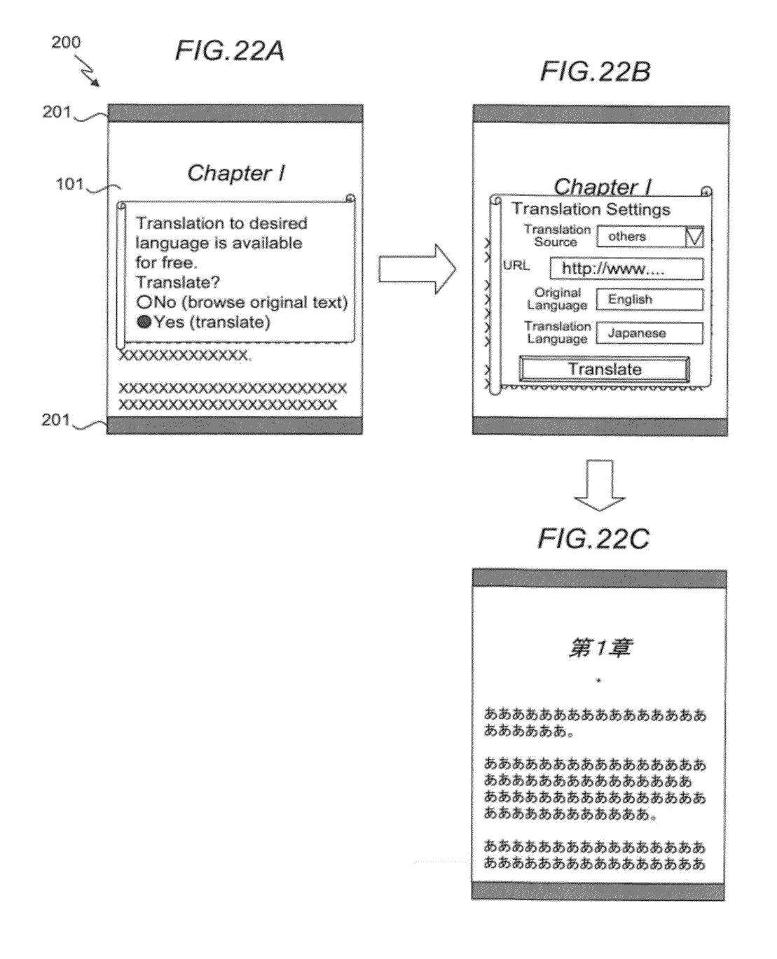

FIG. 22 is a diagram showing an example of the screen when translating and browsing the text information of the content 101 in the viewer 21. FIG. 22A shows an example of the screen when the user makes the request for translation of the content 101 in the step S611 in FIG. 21. When the content 101 has the text information, the text information can be translated.

When selecting to carry out the translation here, the viewer 21 displays a setting screen for the translation as shown in FIG. 22B. Here, the external translation tool 34 can be specified as the source of the translation. It is also possible to directly specify the URL of the translation site other than those defined in advance. Note that, by saving the information in the viewer 21 in the step S614 in FIG. 21, it can be set as the default value for the next and following translations including the translation of another content 101. Furthermore, it is also possible to specify the translation language from the translatable languages.

When the translation is carried out after the setting of the translation, the text information after the translation is displayed as shown in FIG. 22C. In displaying the text information, the viewer 21 may read the text information after the translation to display it, or the viewer 21 may display the text information by browsing the external translation tool 34 through the translation unit 152 of the content server 100.

Note that, in the example of FIG. 22, the content 101 made up of the text is set as the object of the translation, but an image content (for example, comic) in which sentences described in speech balloons and notes are inserted as the text information in the content 101 can also be translated by handling the part of the text information in the same manner as the content 101 made up of the text. The same is true of the above-described addition of the comment to the keyword and dictionary search. Note that, in the translation, for example, by re-encoding the translation result in the external translation tool 34 to an appropriate file format by the translation unit 152 and others to obtain the content 101 after the translation, the text information of the translation result can be inserted at an appropriate position in the image of the content 101.

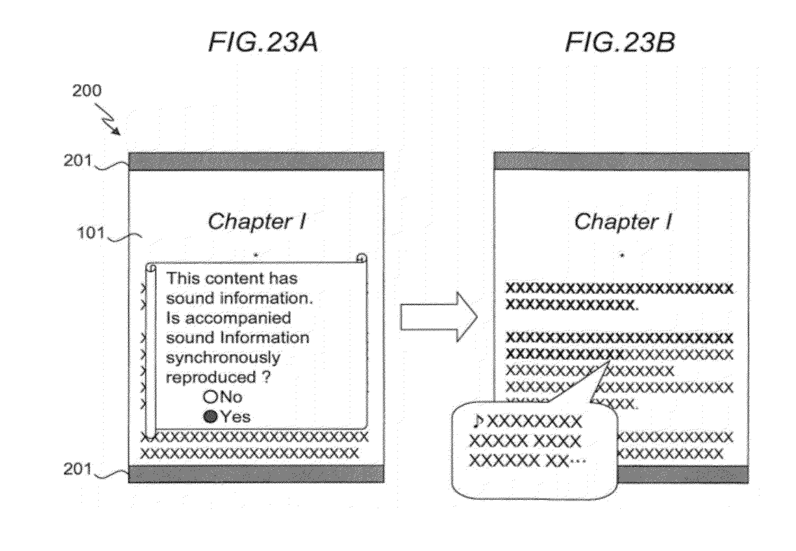

Furthermore, in the present embodiment, when the content 101 is accompanied by the sound information or the content 101 and the sound information are managed in association with each other, the text information and the sound information of the content 101 are synchronously reproduced and displayed in the viewer 21. FIG. 23 is a diagram showing an example of the screen in the case of synchronously reproducing the sound information when browsing the content 101 in the viewer 21. For example, when browsing the content 101 in the screen as shown in FIG. 10C, if the synchronous reproduction of the text information and the sound information of the target content 101 is possible, the viewer 21 can confirm the user whether to carry out the synchronous reproduction by displaying the screen as shown in FIG. 23A.

When the user selects to carry out the synchronous reproduction of the text information and the sound information, the reproduction processing unit 110 of the content server 100 synchronously reproduces the text information and the sound information of the content 101 by the sound synchronization unit 153 in reproducing the content 101 by streaming or the like. At this time, for example, the viewer 21 clearly shows the part being reproduced in sound in the text of the content 101 as shown in FIG. 23B. As the technology for the synchronous reproduction in the content server 100, for example, the prior art technology known in the karaoke equipment, the language study system and others can be utilized as described above.

As described above, in the electronic book system 1 according to an embodiment of the present invention, various services capable of further improving the user convenience can be provided by managing the text information (including the information relating to the comments added by users) of the electronic book (content 101) in the content server 100 in an integrated fashion and sharing the information with a plurality of users and also performing the acquisition and analysis of the contents of the text information by the comment processing unit 130, the advertisement processing unit 140, the reproduction support unit 150 and others.

More specifically, the user can add the comment of the text information to the content 101 which the user is browsing and the comment can be shared with other users. This comment can be added not only to a unit such as the content 101, a page or a frame but also to a text (keyword). At this time, for example, it is also possible to provide a comment to a specific user and post a comment to various types of SNS sites. Also, when adding a comment to an article and news, the contents of the comment can be more clarified by setting an opinion and quoting a past article.

Furthermore, by performing the analysis based on the accumulation of the information relating to the comments added by the users, the optimum content 101 can be recommended and the advertisement can be displayed to the user. It is also possible to add the freehand memo to the content 101 as a comment and to share the freehand memo with other users. Since the text information of these comments and freehand memos is managed separately from the content 101, the information can be managed without regard to the platform of the terminal 20 to browse the content 101 and can be displayed in the terminal 20 with different platform.

Furthermore, it is also possible to carry out the dictionary search to the keyword by using the text information of the electronic book, automatically translate the text and display it, and synchronously reproduce the sound information.

In the foregoing, the invention made by the inventors of the present invention has been concretely described based on the embodiments. However, it is needless to say that the present invention is not limited to the foregoing embodiments and various modifications and alterations can be made within the scope of the present invention.

The present invention can be utilized for the electronic book system and the content server that provide various types of services including the information sharing and others by using the text information relating to the electronic book.

While the present invention has been illustrated and described with respect to a particular embodiment thereof, it should be appreciated by those of ordinary skill in the art that various modifications to this invention may be made without departing from the spirit and scope of the present invention.

1. An electronic book system comprising:
a content server which retains and manages a content including an electronic book and provides a service regarding a browse of the content including the electronic book through a network; and
one or more terminals which include viewers connected to the content server through the network to browse the electronic book,
wherein the viewer has a comment input unit which receives an input of a comment to be added to a desired position of the electronic book from a user and transmits information including the comment and the position to add the comment to the content server, and
the content server has a comment processing unit which retains the information of the comment transmitted from the viewer in a comment storage unit in association with the information of the user and the position to add the comment, and which acquires the information of the comment added by each user to a position of the browsing electronic book from the comment storage unit to display it in the viewer when the user browses the electronic book by using the viewer.

2. The electronic book system according to claim 1,
wherein the comment input unit of the viewer receives a specification of a range of characters in text information of the electronic book from the user and then sets the range of the characters as a position to add the comment, and
the comment processing unit of the content server retains the information of the comment transmitted from the viewer in the comment storage unit in association with the information of the user and the range of the characters regarding the position to add the comment, and displays that the comment is added to the range of the characters in the browsing electronic book when the user browses the electronic book by using the viewer.

3. The electronic book system according to claim 1,
wherein the viewer further includes a freehand memo input unit which receives an input of a freehand memo to be added to a desired position of the electronic book from the user and transmits information including the freehand memo and the position to add the freehand memo to the content server, and
the comment processing unit of the content server retains the information of the freehand memo transmitted from the viewer in a freehand memo storage unit in association with the information of the user and the position to add the freehand memo and stores information of update history, and acquires the information of the freehand memo added by the user to the position of the browsing electronic book from the freehand memo storage unit to display it in the viewer when the user browses the electronic book by using the viewer.

4. The electronic book system according to claim 3,
wherein, when another user specified by the user browses the electronic book by using the viewer, the comment processing unit of the content server acquires the freehand memo retained in the freehand memo storage unit from the freehand memo storage unit to display it at a corresponding position of the electronic book in the viewer.

5. The electronic book system according to claim 1,
wherein the comment input unit of the viewer receives an input of a target user to which the comment from the user is added and transmits information including the comment, the position to add the comment and the target user to the content server, and
when the user browses the electronic book by using the viewer, the comment processing unit of the content server acquires the information of the comment added to the user himself/herself at the position of the browsing electronic book from the comment storage unit and displays it in the viewer.

6. The electronic book system according to claim 1,
wherein the content server can access an external comment posting system by an instruction from the user through the terminal, and the comment processing unit posts the comment added by the user by using the viewer also to the comment posting system.

7. The electronic book system according to claim 1,
wherein the comment input unit of the viewer receives an input of an opinion to the electronic book to which the comment is added from the user and transmits information including the comment, the position to add the comment and the opinion to the content server, and
the comment processing unit of the content server puts the information of the comment and the information of the opinion transmitted from the viewer together and retains them in the comment storage unit in association with the information of the user and the position to add the comment.

8. The electronic book system according to claim 1,
wherein, when the user inputs the comment to the desired position of the electronic book, the comment input unit of the viewer can insert a link to a past electronic book into the comment.

9. The electronic book system according to claim 1,
wherein the content server further includes an advertisement processing unit which determines information regarding an advertisement and/or other recommended electronic book displayed at a predetermined display position of the electronic book in the viewer based on information including at least one of text information of the electronic book, information of the comment added to the electronic book and information relating to the user who browses the electronic book when the comment processing unit displays the electronic book and the comment in the viewer, and which displays information relating to the determined advertisement and/or other recommended electronic book at the display position of the electronic book in the viewer when the user browses the electronic book by using the viewer.

10. The electronic book system according to claim 1,
wherein the viewer further includes a dictionary search request unit which receives a specification of a range of characters in text information of the electronic book from the user and transmits a request of a dictionary search using the range of the characters as a search keyword to the content server, and
the content server further includes a dictionary search unit which carries out a search using a dictionary tool based on the search keyword transmitted from the viewer and displays a search result in the viewer.

11. The electronic book system according to claim 1,
wherein the viewer further includes a translation request unit which transmits a translation request of text information of the electronic book from the user to the content server, and
the content server further includes a translation unit which translates the text information of the electronic book by a translation tool based on the translation request transmitted from the viewer and displays text information of a translation result in the viewer.

12. The electronic book system according to claim 1,
wherein the viewer further includes a sound reproduction request unit which transmits a reproduction request of sound information of the electronic book from the user to the content server, and
the content server further includes a sound synchronization unit which synchronously reproduces text information and sound information of the electronic book in the viewer based on the reproduction request transmitted from the viewer.

13. The electronic book system according to claim 1,
wherein the viewer further includes a freehand memo input unit which receives an input of a freehand memo added to a desired position of the electronic book from the user and saves information including the freehand memo and the position to add the freehand memo in the terminal.

14. A content server which retains and manages a content including an electronic book and provides a service regarding a browse of the content including the electronic book through a network,
the content server comprising:
a comment processing unit which receives information of a comment to be added to a desired position of the electronic book input by a user from a viewer for browsing the electronic book disposed in a terminal connected to the content server through the network, retains the information in a comment storage unit in association with the information of the user and the position to add the comment, and acquires the information of the comment added by each user to a position of the browsing electronic book from the comment storage unit to display it in the viewer when the user browses the electronic book by using the viewer.

15. The convent server according to claim 14,
wherein the comment processing unit receives a specification of a range of characters in text information of the electronic book input by the user from the viewer to set the range of the characters as a position to add the comment, retains the information of the comment received from the viewer in the comment storage unit in association with the information of the user and the range of the characters regarding the position to add the comment, and displays that the comment is added to the range of the characters in the browsing electronic book when the user browses the electronic book by using the viewer.
